(19) United States
(12) Patent Application Publication
(10) Pub. No.: US 2017/0186052 A1
(43) Pub. Date: Jun. 29, 2017

(54) ELECTRONIC APPARATUS AND CONTROL METHOD THEREOF

(71) Applicant: SAMSUNG ELECTRONICS CO., LTD., Suwon-si (KR)

(72) Inventors: Ho-hyoung YANG, Suwon-si (KR); Do-wan KIM, Gunpo-si (KR)

(21) Appl. No.: 15/378,179

(22) Filed: Dec. 14, 2016

(30) Foreign Application Priority Data
Dec. 24, 2015 (KR) 10-2015-0186688

(51) Int. Cl. G06Q 30/02; G06T 1/00; G06F 3/147; H04L 29/08

(52) U.S. Cl. CPC G06Q 30/0277; H04L 67/24; H04L 67/1095; G06T 1/0007; G06F 3/147

(57) ABSTRACT

Disclosed is an electronic device. The electronic device includes a display, a communicator comprising communication circuitry configured to communicate with an advertisement server, a storage configured to store image data corresponding to identification information of an advertisement received from the advertisement server and image data corresponding to the identification information, and a processor configured to transmit event occurrence information to the advertisement server, in response to an event to display a first screen on the display occurring, and to extract image data corresponding to the received identification information in response to identification information of an advertisement corresponding to the event occurrence information being received from the advertisement server, and provide the data on the first screen.

### CROSS-REFERENCE TO RELATED APPLICATION

This application is based on and claims priority under 35 U.S.C. §119 to Korean Patent Application No. 10-2015-0186688, filed in the Korean Intellectual Property Office on Dec. 24, 2015, the content of which is incorporated by reference herein in its entirety.

### BACKGROUND

1. Field of the Disclosure

The present disclosure relates generally to an electronic apparatus and a control method thereof, and for example, to a method and an apparatus that provides an advertisement service.

2. Description of Related Art

Development in electronic technology enables development and distribution of various types of electronic apparatuses. Particularly, a display device such as a TV and a mobile device which is mostly largely used recently has been rapidly developed for recent several years.

With drastic increase in user needs every year, advertisement has been used as a means for marketing to attract interests of users. Particularly, in a smart TV, advertisement is provided using advertisement data provided from the advertisement server, and a plan to efficiently provide the above is required.

### SUMMARY

An example aspect of the present disclosure provides a method and an apparatus for providing advertisement on a first screen using an advertisement received from the advertisement server and stored therein.

According to an example embodiment of the present disclosure, an electronic device is provided. The electronic device includes a display, a communicator comprising communication circuitry configured to communicate with an advertisement server, a storage configured to store image data corresponding to identification information of an advertisement received from the advertisement server and image data corresponding to the identification information, and a processor configured to transmit event occurrence information to the advertisement server in response to an event to display a first screen on the display occurring, and to extract image data corresponding to the received identification information in response to identification information of an advertisement corresponding to the event occurrence information being received from the advertisement server, and to provide the data on the first screen.

The processor, in response to the electronic device being booted, may transmit booting event occurrence information to the advertisement server to request advertisement data, receive, from the advertisement server, advertisement data including identification information of advertisement and image data corresponding to the identification information and update the storage.

The processor may compare identification information and image data of advertisement stored in the storage with identification information and image data of advertisement included in the received advertisement data and update data stored in the storage to latest version advertisement data.

The advertisement data received from the advertisement server may further include effective period information of the advertisement, and the processor may compare effective period information of the advertisement included in the received advertisement data and effective period information of the advertisement stored in the storage and update the stored data in the storage.

The processor, in response to image data corresponding to identification information of the advertisement received from the advertisement server not being stored in the storage, may request, to the advertisement server, image data corresponding to the identification information of the advertisement and provide the received image data on the first screen.

The processor, in response to image data corresponding to identification information of the advertisement received from the advertisement server not being stored in the storage, may provide image data of different advertisement stored in the storage on the first screen, receive image data corresponding to the received identification information of the advertisement from the advertisement server, and update the storage.

The processor may provide image data of the different advertisement on the first screen and request image data corresponding to the received identification information of advertisement to the advertisement server.

The event occurrence information may include at least one of device information of the electronic device, the event type, and a number of the event occurrence.

According to an example embodiment, a method of controlling an electronic device comprising identification information of advertisement received from an advertisement server and image data corresponding to the identification information, the method includes, transmitting the event occurrence information to the advertisement server in response to an event to display a first screen occurring; and extracting image data corresponding to the received identification information in response to identification information of an advertisement corresponding to the event occurrence information being received from the advertisement server, and providing the data on the first screen.

In response to the electronic device being booted, the method may include transmitting booting event occurrence information to the advertisement server to request advertisement data, receiving, from the advertisement server, advertisement data including identification information of advertisement and image data corresponding to the identification information and updating the storage.

The updating may include comparing identification information and image data of advertisement stored in the storage with identification information and image data of advertisement included in the received advertisement data and updating data stored in the storage to latest version advertisement data.

The advertisement data received from the advertisement server may include effective period information of the advertisement, wherein the updating the storage may include comparing effective period information of the advertisement included in the received advertisement data and effective period information of the advertisement stored in the storage and updating the stored data in the storage.

The method may further include, in response to image data corresponding to identification information of the advertisement received from the advertisement server not being stored in the storage, requesting, to the advertisement server, image data corresponding to the identification information of the advertisement and providing the received image data on the first screen.

The method may further include, in response to image data corresponding to identification information of the advertisement received from the advertisement server not being stored in the storage, providing image data of different advertisement stored in the storage on the first screen; and, receiving image data corresponding to the received identification information of the advertisement from the advertisement server and updating the storage.

The updating the storage may include providing image data of the different advertisement on the first screen and requesting image data corresponding to the received identification information of advertisement to the advertisement server.

The event occurrence information may include at least one of device information of the electronic device, the event type, and a number of the event occurrence.

A recording medium storing a program to execute a method of providing an advertisement of an electronic device including a storage which stores identification information of advertisement received from an advertisement server and image data corresponding to the identification information includes, in response to an event to display a first screen occurring, transmitting the event occurrence information to the advertisement server; and in response to identification information of an advertisement corresponding to the event occurrence information being received from the advertisement server, extracting image data corresponding to the received identification information from the storage and providing on the first screen.

As described above, according to the present disclosure, advertisement data to be provided on the advertisement timing is received ahead and stored, and advertisement can be provided immediately without additional communication with an advertisement server and thus, user convenience is improved.

### BRIEF DESCRIPTION OF THE DRAWINGS

The above and/or other aspects, features, and advantages of the present disclosure will be more apparent from the following detailed description, taken in conjunction with the accompanying drawings, in which like reference numerals refer to like elements, and wherein:

FIG. 1 is a diagram illustrating an example electronic system, according to an example embodiment of the present disclosure;

FIG. 2 is a block diagram illustrating an example configuration of the electronic apparatus, according to an example embodiment of the present disclosure;

FIG. 3 is a block diagram illustrating an example configuration of the electronic apparatus illustrated in FIG. 2;

FIG. 4 is a diagram illustrating various example modules stored in a storage;

FIG. 5 is a block diagram illustrating an example configuration of a server, according to an example embodiment of the present disclosure;

FIG. 6 is a diagram illustrating an example screen for providing an advertisement, according to an example embodiment of the present disclosure;

FIG. 7 is a flowchart illustrating an example method for providing an advertisement, according to a user input, according to an example embodiment of the present disclosure;

FIG. 8 is a flowchart illustrating an example method for advertisement data update, according to another example embodiment of the present disclosure;

FIG. 9 is a flowchart illustrating an example method for providing advertisement data, according to another example embodiment of the present disclosure;

FIG. 10 is a flowchart illustrating an example method for providing advertisement data, according to still another example embodiment of the present disclosure; and

FIG. 11 is a sequence diagram illustrating an example operation relation between the electronic apparatus and an advertisement server, according to another example embodiment of the present disclosure.

### DETAILED DESCRIPTION

Example embodiments of the present disclosure are described in greater detail with reference to the accompanying drawings. The same or similar components may be designated by the same or similar reference numerals although they are illustrated in different drawings. Detailed descriptions of constructions or processes known in the art may be omitted to avoid obscuring the subject matter of the present disclosure.

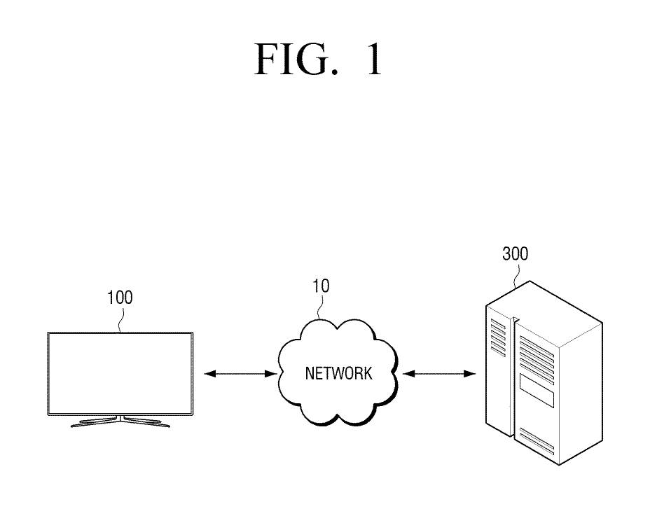

FIG. 1 is a diagram illustrating an example electronic system, according to an example embodiment of the present disclosure. According to FIG. 1, an electronic system 1000 includes an electronic device 100 and an advertisement server 300.

The electronic device 100 may be embodied as a smart TV as illustrated but it is not limited thereto and may be embodied as various types of devices such as a tablet PC, mobile phone, e-book, desktop personal computer, laptop personal computer, netbook computer, personal digital assistant (PDA), portable multimedia player (PMP), MP3 player, mobile medical device, camera, camcorder, e-frame or wearable device (for example, head-mounted-device (HMD) smart watch, e-cloth, e-bracelet, e-necklace, etc.), Near Eye Display (NED), large format display (LFD), digital signage, Digital Information Display (DID), video wall, and projector display, or the like.

The electronic device 100 may provide an advertisement service which displays various advertisements received from the advertisement server 300. To do this, the electronic device 100 may be embodied to store various programs to provide an advertisement service. For example, the advertisement service may be a service providing advertisement of various fields such as various contents, applications, products, and communication services.

For example, when the electronic device 100 is embodied as a smart TV, the electronic device 100 may provide an advertisement received from the server 300 from a TV. For example, the electronic device 100, when a first screen is executed, may provide advertisement on the first screen. For example, the first screen indicates a screen including various menus which are seen first after being booted. This can be a home screen provided during viewing according to a user command (e.g., a preset button input) which is not seen only during booting. In the meantime, advertisement can be provided on a different screen other than the first screen according to operation method of the electronic device 100 and contracts with advertisement provider, and this will be described later.

The advertisement server 300 communicates with the electronic device 100 and transmits various advertisement data to the electronic device 100. The advertisement server 300 may communicate with the electronic device 100 via any suitable network 10. For example, the server 300 may transmit, to the electronic device 100, advertisement data which is contracted during a preset contract period. In the present disclosure, ‘advertisement data’ may refer, for example, to a concept including both identification information of advertisement and image data corresponding to the identification information.

In the meantime, the server 300 may provide advertisement data corresponding to the electronic device 100 based on device information of the electronic device 100. For example, the server 300 may provide advertisement suitable for the electronic device 100 which is selected based on device information such as a country code, model, Infolink Firmware, App Targeting availability, and game panel presence or the like.

Hereinbelow, a method for providing advertisement received from the advertisement service 300 to a user will be further described according to various example embodiments with reference to drawings.

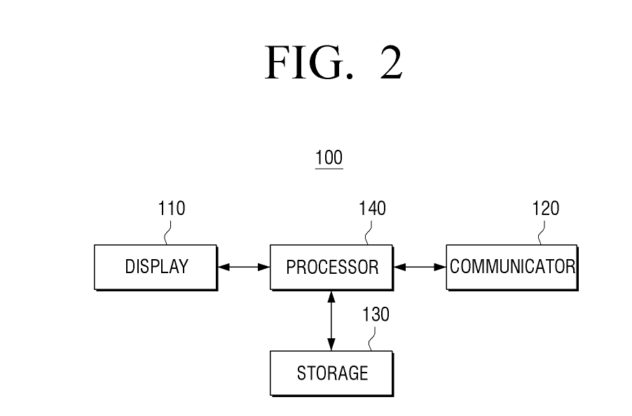

FIG. 2 is a block diagram illustrating an example configuration of the electronic apparatus, according to an example embodiment of the present disclosure.

Referring to FIG. 2, the electronic device 100 includes a display 110, a communicator (e.g., including communication circuitry) 120, a storage 130, and a processor (e.g., including processing circuitry) 140.

The display 110 may provide various content screens through the electronic device 100. Herein, contents may include various contents such as an image, a video, a text, and music, an application execution screen including various contents, and Graphic User Interface (GUI).

In the meantime, the display 110 may be embodied as various displays such s a liquid crystal display, organic light-emitting diode, Liquid Crystal on Silicon (LCoS), and Digital Light Processing (DLP), or the like, but is not limited thereto. In addition, the display 110 may be composed of a transparent material and embodied as a transparent display which displays information.

In the meantime, the display 110 may be embodied as a touch screen having a mutual layer with a touch pad, and in this case, the display 110 may be used as a user interface other than an output device.

The communicator 120 may include various communication circuitry that communicates with various external devices including the advertisement server 300.

The communicator 120 may include various circuitry to communicate with the advertisement server 300 using wired/wireless LAN, WAN, Ethernet, Bluetooth, Zigbee, IEEE 1394, Wifi or Power Line Communication (PLC).

In the above, it is described that the communicator 120 is an element, but according to the example embodiments, when the advertisement server 300 is embodied as a plurality of servers, it can be embodied as separate communicator which communicates with each server. In this example, a communicating method with each server of the communicator 120 can be the same or different.

The storage 130 stores various data such as operating system (0/S) software module to drive the electronic device 100 and various multimedia contents.

For example, the storage 130 stores identification information of advertisement received from the advertisement server 300 and image data corresponding to the identification information. Hereinbelow, it is described that identification information of advertisement and image data corresponding to the identification information as advertisement data.

For example, the storage 130 may include at least one of an internal memory or an external memory. The internal memory, for example, may include at least one of a volatile memory (e.g., dynamic RAM (DRAM), static RAM (SRAM), or synchronous dynamic RAM (SDRAM), etc.), non-volatile Memory (e.g., one time programmable ROM (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), hard drive, or solid state drive (SSD)).

The external memory may further include flash drive, for example, compact flash (CF), secure digital (SD), micro secure digital (Micro-SD), mini secure digital (Mini-SD), extreme digital (xD), multi-media card (MMC) or memory stick. The external memory can be functionally and/or physically connected to the electronic device 100 through various interfaces.

The processor 140 may include various processing circuitry configured to control overall operations of the electronic device 100.

For example, the processor 140, when a preset event occurs on the display 110, may transmit event occurrence information to the advertisement server 300, and receive from the advertisement server 300 identification information of the advertisement corresponding to the event occurrence. For example, the event occurrence information may include at least one of an event type and device information of the electronic device 100 (e.g., country code, manufacturer, product, model, Infolink Firmware, App Targeting availability, and function (Game Panel presence), etc.).

For example, the processor 140, when an event to display the first screen occurs, may transmit information on the event and the event occurrence information including device information of the electronic device 100 to the advertisement server 300, and receive identification information of advertisement corresponding to the device information. For example, event information may include information regarding an event type and information on an event frequency.

According to an example embodiment, identification information of advertisement based on device information and event type can be received. For example, in case of the same device, advertisement provided on the first screen can be different from advertisement provided on a specific menu screen (for example, game menu screen), and in this case, different identification information of advertisement can be received according to an event of displaying which screen.

According to another example embodiment, device information and identification information based on event frequency can be received. For example, in case of the same device with the same type events (for example, first screen display event), advertisement can be set differently according to what sequence the event has after the event is powered on.

According to still another example embodiment, when an advertisement providing event type is restricted, it is possible that event occurrence information transmits only device information to the advertisement server 300. By transmission of device information only, event occurrence can be notified to the advertisement server 300.

In the meantime, when the event occurrence information for providing advertisement includes device information only, event occurrence information should be transmitted in a type different from the booting event. For example, when booting event occurs, the event occurrence information transmitted to the advertisement server 300 should include information regarding an event type.

The processor 140 extracts, from the storage 130, image data corresponding to identification information of the received advertisement and provides on the screen. For example, identification information of the advertisement may include various types of IDs (for example, serial number) assigned to advertisements to identify advertisement. In addition, according to an example embodiment, identification information of advertisement may further include information of identifiable various types, for example, advertisement manufacturer, advertisement medium information, and advertisement information, or the like.

In addition, a preset event to receive identification information of advertisement can be an event to display a first screen, but it is not limited thereto. When advertisement is provided to a different screen (for example, home screen, etc.) other than a first screen according to operation type of the electronic device 100 and contract with advertisement provider, it can be an event to display the corresponding screen.

For example, when the electronic device 100 operates to provide a screen to provide a screen performing a similar function, rather than a first screen, advertisement identification information can be received according to an event that the screen is displayed.

As another example, when the electronic device 100 operates to provide a first screen immediately after being booted, identification information of advertisement for booting event can be received.

Identification information of an advertisement to be provided on a first screen can be pre-received and stored before an event to provide advertisement. For example, in case of advertisement which is provided on a screen which is different from a first screen according to characteristic of advertisement, the advertisement can be received when the previous event occurs other than an event to display a screen where the event is provided. For example, when a user selects a game category for game advertisement, when it is provided on the first screen, if an event to display a home screen occurs or with another operation, identification information of advertisement can be pre-requested and received.

In addition, the processor 140, when booting event of the electronic device 100 occurs, may transmit booting event occurrence information to the advertisement server 300, to request advertisement data to provide advertisement, receive advertisement data including identification information and image data corresponding to identification information from the advertisement server 300, store it in the storage 130, or update the storage 130. For example, image data may be image files having filename extension such as JPG, JEPG, PNG, BMP, and GIF, but it is not limited thereto. In addition, image data can include at least one of a still image and a video image.

In other words, the processor 140, while advertisement data is pre-stored in the storage 130, provides advertisement using stored image data of advertisement, and when event occurs, time required to download image data of advertisement from the advertisement server 300 and display the same can be reduced. Here, the processor 140 may store downloaded image data as it is, but also can process data as a type to be displayed at advertisement timing and stored. For example, the downloaded image data can be processed and stored as a UI which can be immediately displayed.

The processor 140 may compare identification information of advertisement prestored in the storage 130 and image data, identification information included in advertisement data received from the advertisement server 300 when a booting event occurs and image data, and update advertisement data stored in the storage 130 to advertisement data in the latest version. The processor 140, when advertisement data is not stored in the storage 130, for example, during the initial booting after purchasing a product, may receive advertisement data from the advertisement server 300 and receive the data.

According to an example embodiment, the advertisement data received from the advertisement server 300 may further include effective period information of advertisement.

In this example, the processor 140, by comparing effective period information of advertisement included in the received advertisement data and effective period information stored in the storage 130 and update data stored in the storage 130. For example, the processor 140, from among advertisement data stored in the storage 130, may update advertisement data with elapsed effective period to new advertisement data.

For example, the processor 140, when identification information of advertisement included in the received advertisement data, for example, advertisement ID is not stored in the storage 130, may store advertisement data including advertisement ID, image data, and advertisement effective period as new advertisement data.

In addition, the processor 140, when advertisement ID included in the received advertisement data is stored in the storage 130, but stored image data is different from the received image data, may substitute image data stored in the storage 130 with received image data.

In addition, the processor 140, when advertisement ID included in the received advertisement data is stored in the storage 130 and image data is identical, but stored effective period information is different from received effective period information, may substitute effective period information stored in the storage 130 with received effective period information.

In addition, the processor 140, when advertisement ID included in the received advertisement data is stored in the storage 130, but stored image data and effective period information are different from the received image data and effective period information, image data stored in the storage 130 and effective period information can be substituted with received image data and effective period information.

In this example, the processor 140, based on image data, that is, file type of image file, correction date, size, version, and play time, etc., may determine whether the image data is identical, or based on actual image details through image data video analysis, determine whether image data is identical.

In the meantime, when there are a plurality of advertisements which need to be provided from the electronic device 100, advertisement data may further include information regarding a list of advertisement data, providing numbers of each advertisement, organic providing time of each advertisement, and replaceable advertisement. Here, organic providing time of each advertisement can be a sequence of providing a plurality of advertisements, and replaceable advertisement, when the image data of the advertisement is not stored in the storage 130, may be replaceable advertisement which can be provided at the advertisement timing.

In addition, the processor 140, simultaneously with displaying advertisement data on the first screen, based on the pre-received advertisement data list, when advertisement data which is to be provided later is not received, may request the advertisement data to the advertisement server 300 and receive the data.

In addition, the processor 140, when identification information of advertisement received from the advertisement server 300 is not stored in the storage 130, may request to the advertisement server 300 image data corresponding to identification information of the received advertisement, and provide received image data on the first screen upon request.

For example, the processor 140, when the advertisement should be provided at the advertisement timing (for example, contract with advertisement provider), image data corresponding to identification information of the received advertisement can be requested to the advertisement server 300 and provide the image data received upon request to the first screen.

In addition, the processor 140, when identification information of advertisement received from the advertisement server 300 is not stored in the storage 130, may provide image data of another advertisement stored in the storage 130 on the first screen, receive image data corresponding to the identification information of the received advertisement from the advertisement server 300 and update the storage 130.

In this example, the processor 140 may provide image data of another advertisement on the first screen, and at the same time, request to the advertisement server 300 image data corresponding to identification information of advertisement to the advertisement server 300.

For example, the processor 140, when it is not necessary to provide the advertisement at the corresponding advertisement timing, but provide within a preset time (e.g., contract with an advertisement provider, etc.), may provide image of another advertisement stored in the storage 130 on the first screen, receive image data corresponding to the received advertisement from the advertisement server 300, update the storage 130, and provide the advertisement to advertisement timing (for example, at the time when the first screen is displayed).

Accordingly, the processor 140, when advertisement providing event occurs, may not need time to download image data from the advertisement server 300, display another advertisement image, and at the time when the first screen is executed, provide image data of the advertisement, that is, image data of the advertisement which is updated and stored in the advertisement server 300.

For example, when timing of providing a specific advertisement is limited to a preset contract period, the electronic device 100 does not necessarily provide advertisement at the timing of receiving advertisement identification information from the advertisement server 300 and thus, the advertisement can be provided at the time when the first screen is executed again.

In the meantime, in the aforementioned example embodiments, event occurrence timing may be timing to receive (for example, receiving a remote control signal corresponding to the button input) a user command corresponding to the event, but it can be within time including threshold time range according to an operation method of the electronic device 100.

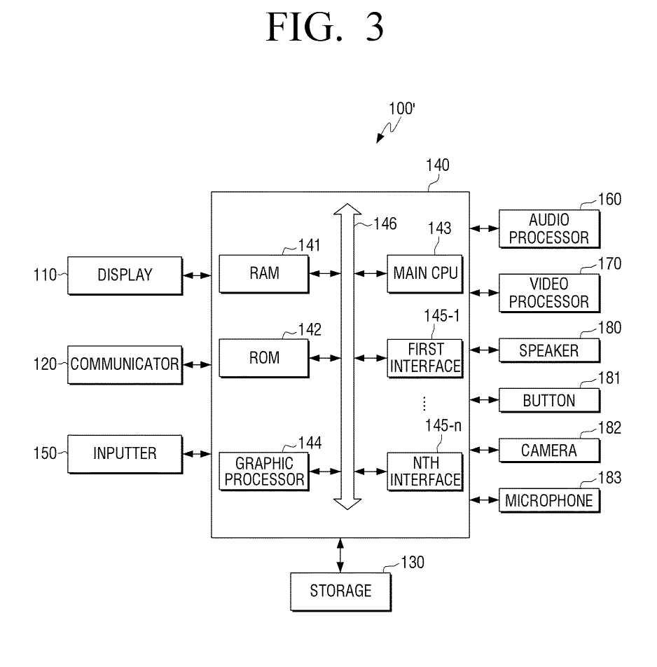

FIG. 3 is a block diagram illustrating an example configuration of the electronic apparatus illustrated in FIG. 2. Referring to FIG. 3, an electronic device 100′ includes a display 110, a communicator (e.g., including communication circuitry) 120, a storage 130, a processor (e.g., including processing circuitry) 140, an inputter (e.g., including input circuitry) 150, an audio processor 160, a video processor 170, a speaker 180, a button 181, a camera 182, and a microphone 183. From among the features illustrated in FIG. 3, the features overlapping with FIG. 2 will not be further described. A more detailed description of the various elements of the electronic device 100′ is provided below.

As described above, the storage 130 stores various data such as operation system (O/S) software module to drive the electronic device 100 and multimedia contents.

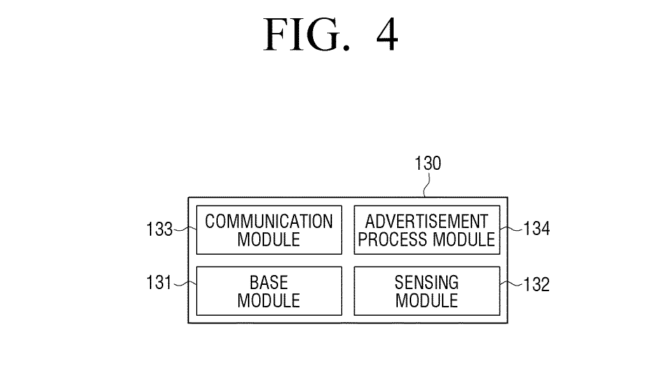

FIG. 4 is a diagram illustrating various example modules stored in a storage. According to FIG. 4, the storage 130 may store therein a base module 131, a sensing module 132, a communication module 133, and advertisement processing module 134. The various modules may, for example, be software or program modules including instructions to be executed by the processor 140.

The base module 131 may refer, for example, to a basic module which processes a signal transferred from each hardware included in the electronic device 100 to deliver the signal to an upper layer module. The base module 131 includes storage module which manages DB or registry, security module to support certification, permission, and secure storage of hardware, and network module to support network connection.

The sensing module 132 may refer, for example, to a module to analyze and manage information received from the electronic device 100 and collected by sensors. The sensing module 132 may include illumination recognition module and NFC recognition module.

The communication module 133 may refer, for example, to a module to communicate with outside. The communication module 133 may include a device module (e.g., advertisement data request module, advertisement data receiving module) used for communication with an external device, in particular, the advertisement server 300, a messenger program, and a messaging module such as Short Message Service (SMS) & Multimedia Message Service (MMS) program and e-mail program.

The advertisement processing module 134 may refer, for example, to a module to process advertisement data provided on a first screen. The advertisement processing module 134, when a booting event occurs, receives advertisement data from the advertisement server 300 and store the data, and when the firs screen display event occurs, provides the advertisement data on the first screen.

In addition, the storage 130 may further include a presentation module (not shown) for composing a display screen. The presentation module (not shown) may include a multimedia module to play and output multimedia contents and UI rendering module to process UI and graphic processing.

Referring back to FIG. 3, processor 140 may include various processing circuitry, such as, for example, and without limitation, one or more of central processing unit (CPU), controller, application processor (AP), communication processor (CP), or ARM processor. The processor 140, for example, may process computation or data processing regarding control and/or communication of at least one other elements of the electronic device 100.

For example, the processor 140 includes RAM 141, ROM 142, main CPU 143, graphic processor 144, first to n^{th} interface 145-1˜145-n, and bus 146.

The RAM 141, ROM 142, main CPU 143, graphic processor 144, first to n^{th} interface 145-1˜235-n can be connected through the bus 146.

The first to n^{th} interface 145-1 to 145-n are connected with the aforementioned various elements. One of the interfaces can be network interface which is connected to an external device through network.

The main CPU 143, by accessing the storage 130, performs booting using O/S stored in the storage 130 and perform various operations using programs, contents, and data stored in the storage 130.

The ROM 142 stores therein a command set for system booting. When turn-on command is input and power is supplied, the main CPU 143, according to a command stored in the ROM 142, copies the O/S stored in the storage 130 to the RAM 141, and execute O/S to boot system. If booting is completed, the main CPU 143 copies various programs stored in the storage 130 to the RAM 141, execute a program copied in the RAM 141 to perform various operations.

The graphic processor 144, using the calculator (not shown) and the renderer (not shown) generates a screen including various objects such as an icon, image, and text. The calculator (not shown), based on layout of a screen based on the received control command, calculates attribute values such as coordinate value, type, size, and color to display objects. The renderer (not shown), based on the attribute value calculated by the calculator (not shown), generates a screen of various layouts including objects. For example, the graphic processor 144 may generate a UI screen to provide various guide information regarding an environment condition. The operations of the processor 140 can be done by a program stored in the storage 130.

The inputter 150 includes various input circuitry configured to receive various user commands. Non-limiting examples of input circuitry include a touch screen, a physical button or key 181, or the like.

In particular, the inputter 150 receives a user command to display a first screen and a user command to perform booting.

The inputter 150 can be implemented using various input circuitry according to implementation of the electronic device 100. For example, when the electronic device 100 is embodied as a digital TV, the inputter 150 may be implemented as a remote controller receiver to receive a remote control signal from a remote control device (not shown), but it is not limited thereto, and can be embodied as a camera to receive a user motion, a microphone to receive user voice, and a key provided on a panel, or the like.

The audio processor 160 may refer, for example, to an element to perform processing of audio data. The audio processor 160 may perform various processing such as decoding, amplification and noise filtering of audio data.

The video processor 170 may refer, for example, to an element to perform processing of video data. The video processor 170 may perform various image processing such as decoding, scaling, noise filtering of video data, frame rate conversion, and resolution conversion.

The speaker 180 may refer, for example, to an element to output various notification sound, voice message and audio processed by the audio processor 160. The camera 182 may refer, for example, to an element to film a still image or a video according to control of a user. The camera 182 may be embodied as a front camera and a rear camera. The microphone 183 may refer, for example, to an element to receive user voice or other sound to convert audio data. The processor 140 may use user voice input through the microphone 183 during the calling process, or convert to audio data, and store in the storage 130. When there are the camera 182 and the microphone 183, the processor 140 may perform various control operations such as channel zapping according to user motion recognized through user voice input through the microphone 183 or the camera 182. In addition, various external input ports to be connected with various external terminals such as headset, mouse, and LAN can be further included.

In the meantime, FIG. 3 is an example of the configurations of the electronic device 100′, and according to an example embodiment, some elements of FIG. 3 can be omitted or changed, and other elements can be further added.

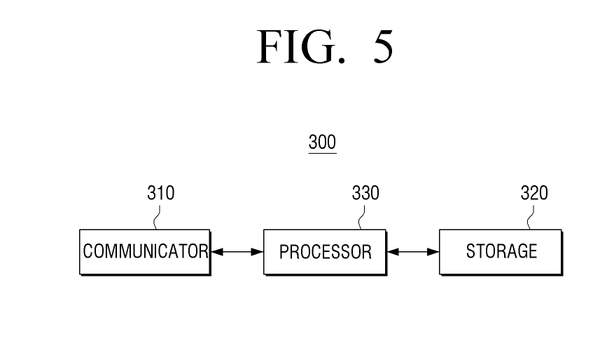

FIG. 5 is a block diagram illustrating an example configuration of a server, according to an example embodiment of the present disclosure.

Referring to FIG. 5, an advertisement server 310 includes the communicator (e.g., including communication circuitry) 310, a storage 320, and a processor (e.g., including processing circuitry) 330.

The communicator 310 communicates with the electronic device 100.

For example, the communicator 310, according to a preset event, includes various communication circuitry that transmits advertisement data and identification information of advertisement to the electronic device 100.

The communicator 310, using wired/wireless LAN, WAN, Ethernet, Bluetooth, Zigbee, IEEE 1394, Wifi, or Power Line Communication (PLC), may communicate with the electronic device 100.

The storage 320 stores therein the operating system (O/S) software module to drive the advertisement server 300 and various advertisement data.

In addition, the storage 320 may store country code, manufacturer, produce, model, Infolink Firmware, App targeting availability, function (game panel presence) of various electronic devices and provide information of available advertisement type, advertisement version, advertisement effective period, advertisement contract period, and advertisement providing timing, etc.

The processor 330 may include various processing circuitry that controls overall operations of the advertisement server 300.

For example, the processor 330, when a preset signal (for example, a signal indicating that a booting event occurs in the electronic device 100) is received from the electronic device 100, may transmit advertisement data including advertisement identification information and advertisement image to the electronic device 100. Here, the advertisement data, according to an example embodiment, may further include information regarding advertisement effective period and the times of advertisement.

In this example, the processor 330, based on device information of the electronic device 100 received from the electronic device 100, may determine information such as an advertisement type to be provided by the electronic device 100, advertisement version, advertisement effective period, and advertisement contract period, and transmit the corresponding advertisement data to the electronic device 100. Here, information regarding the electronic device 100 may include information of at least one of a country code, manufacturer, product, model, Infolink Firmware, App Targeting availability (game panel presence, etc.). For example, the processor 330 may provide a game advertisement only for the electronic device 100 present in the game panel.

In addition, the processor 330, when information regarding the electronic device 100 is not stored in the storage 320, may determine a device having a similar function based on a manufacturer, product name, model name, and function information of the electronic device 100, and transmit advertisement data corresponding to the device to the electronic device 100.

In addition, the processor 330, when a request for transmitting image data is received from the electronic device 100 along with advertisement identification information, may transmit image data corresponding to the advertisement identification information to the electronic device 100.

In the meantime, the detailed descriptions of the processor 330 may be similar to the detailed descriptions of the processor 140 provided on the electronic device 100′, but detailed explanation would be omitted.

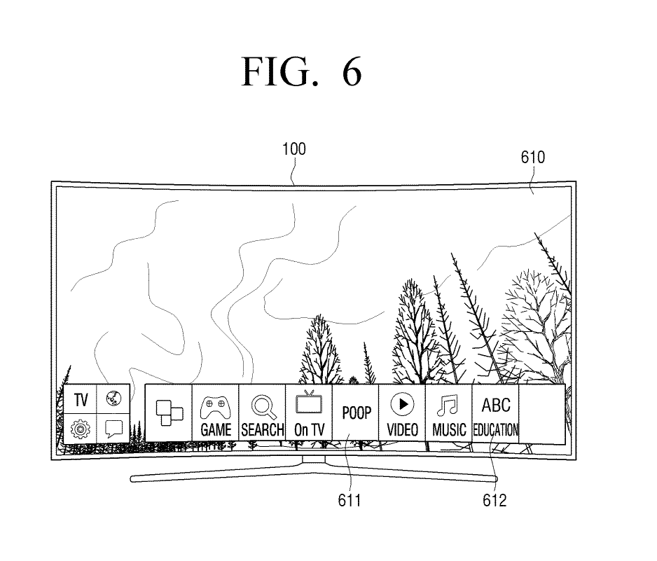

FIG. 6 is a diagram illustrating an example screen for providing an advertisement, according to an example embodiment of the present disclosure.

As illustrated in FIG. 6, when the first screen 610 is displayed, advertisement image 611, 612 can be provided along with various menus provided on the first screen 610. In the meantime, the UI illustrated in FIG. 6 is an example of the first screen, and a UI of the advertisement providing screen is not limited thereto.

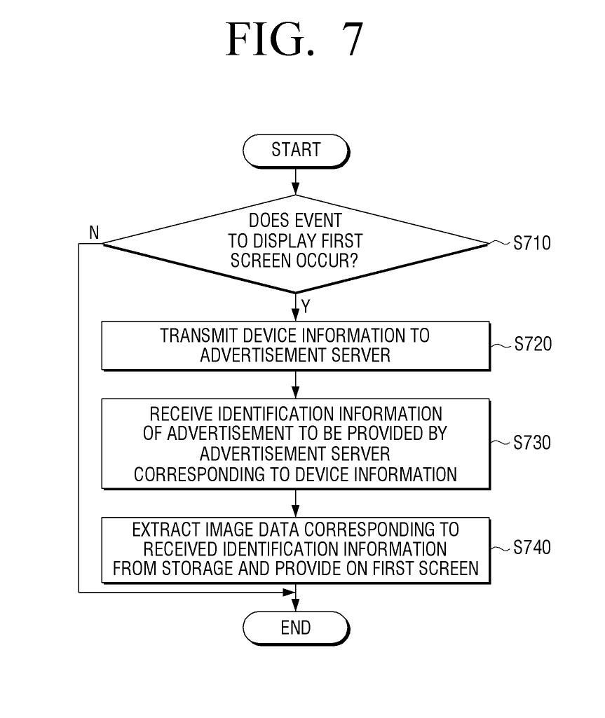

FIG. 7 is a flowchart illustrating an example method for providing an advertisement, according to a user input, according to an example embodiment of the present disclosure.

According to an example method for providing advertisement as illustrated in FIG. 7, the electronic device 100, when an event to display the first screen occurs on the display (S710:Y), transmits device information of the electronic device 100 to the advertisement server 300, in step 720.

The electronic device 100 receives, from the advertisement server 300, advertisement identification information corresponding to device information of the electronic device 100, in step 730. For example, the advertisement server 300, based on the device information of the electronic device 100, may transmit identification information of advertisement to be provided by the electronic device 100 to the electronic device 100.

Thereafter, the electronic device 100 extracts image data corresponding to identification information of the received advertisement from the storage and provides on the first screen, in step 740. Accordingly, it is not necessary to download image data additionally and advertisement providing time is shortened and thus, advertisement exposure time is extended. In addition, a user, while downloading an advertisement image, does not need to view an unnecessary image provided on a screen.

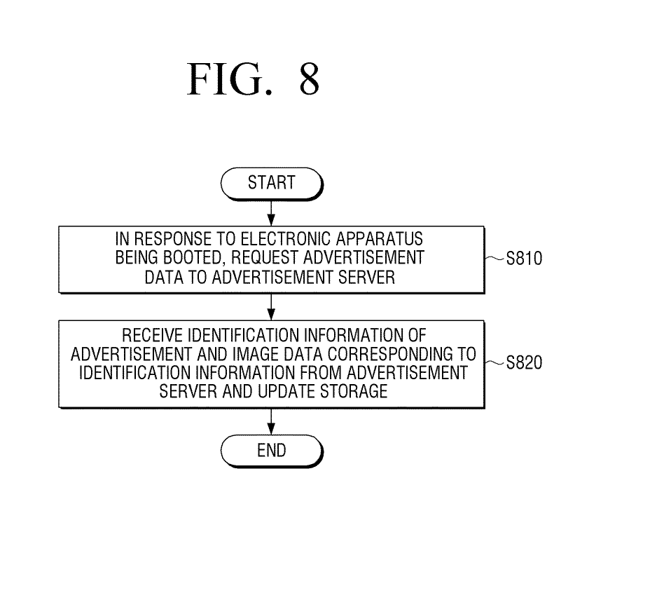

FIG. 8 is a flowchart illustrating an example method for advertisement data update, according to another example embodiment of the present disclosure.

According to a method of updating advertisement data as illustrated in FIG. 8, the electronic device 100, when a booting event occurs, requests advertisement data to the advertisement server 300, in step 810.

Then, the electronic device 100 receives advertisement data from the advertisement server 300 including “identification information of advertisement and image data corresponding to the identification information” and updates storage where advertisement data is stored (S820). For example, received advertisement data may further include information regarding advertisement effective period according to an example embodiment.

For example, the electronic device 100 may compare advertisement identification information included in the received advertisement data, image data, and advertisement effective period with advertisement identification information, image data, advertisement effective period stored in the storage and update the data to latest data.

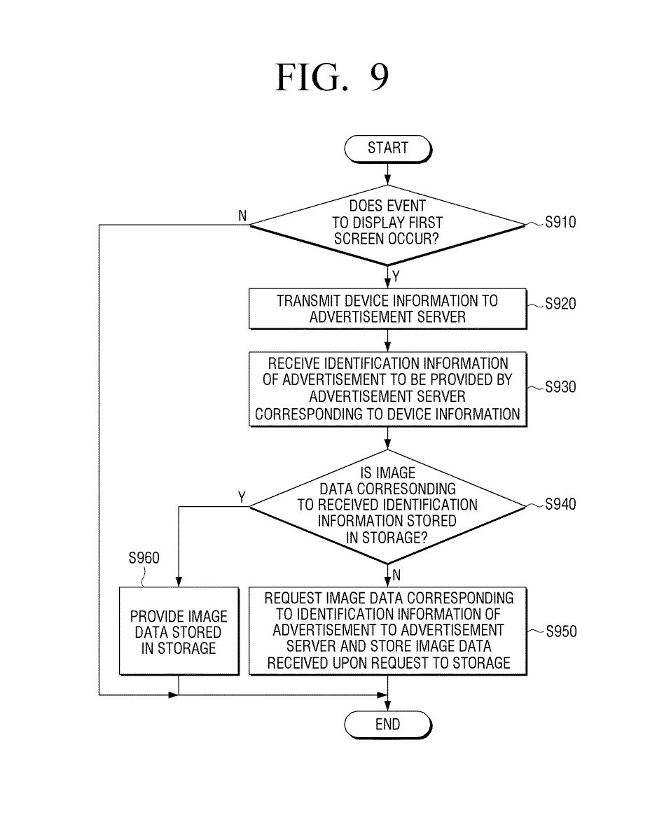

FIG. 9 is a flowchart illustrating an example method for providing advertisement data, according to another example embodiment of the present disclosure.

According to a method for providing advertisement as illustrated in FIG. 9, the electronic device 100, when an event to display the first screen on the display occurs (S910:Y), device information of the electronic device 100 is transmitted to the advertisement server 300, in step 920.

Then, the electronic device 100 receives, from the advertisement server 300, identification information of advertisement corresponding to device information of the electronic device 100, in step 930. For example, the advertisement server 300, based on device information of the electronic device 100, may transmit identification information of advertisement to be provided from the electronic device 100 to the electronic device 100.

Thereafter, the electronic device 100 determines whether advertisement image data corresponding to identification information of the advertisement is stored in the storage, in step 940.

In step 940, when image corresponding to identification information of advertisement received from the advertisement server 300 is not stored in the storage (S940:N), image data corresponding to identification information of advertisement can be requested immediately to the advertisement server 300 and image data received from the server can be stored in the storage. The disclosure is not limited thereto, and image data received according to a request can be provided on the first screen, in step 950. In the meantime, when identification information of advertisement received from the advertisement server 300 is stored in the storage (S940:N), image data stored in the storage can be extracted and provided, in step 960.

For example, when the corresponding event occurs, if it is set that the advertisement is provided, image data of the advertisement can be requested to the advertisement server 300 and provided on the first screen.

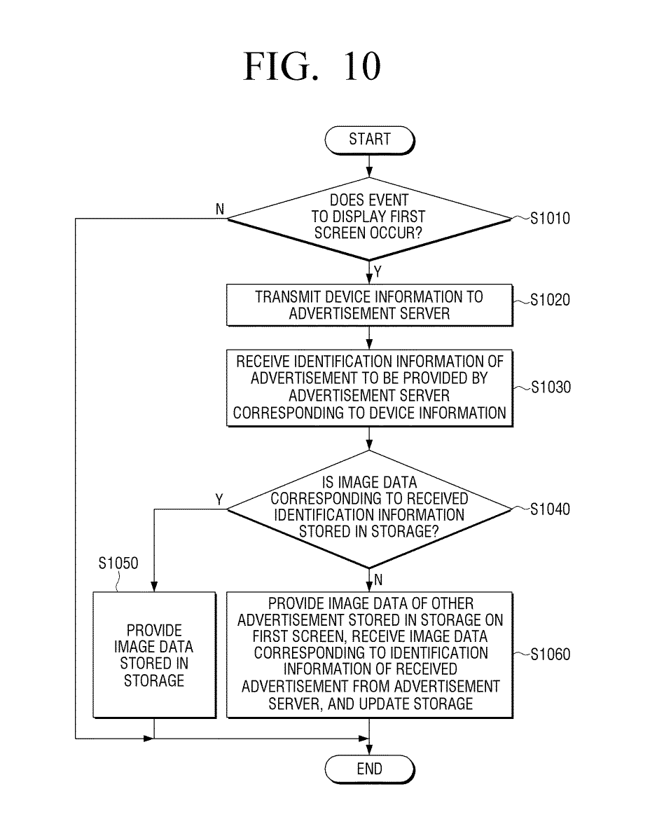

FIG. 10 is a flowchart illustrating an example method for providing advertisement data, according to still another example embodiment of the present disclosure.

According to a method for providing advertisement as illustrated in FIG. 10, the electronic device 100, when an event to display the first screen on the display occurs (S1010:Y), transmits device information of the electronic device 100 to the advertisement server 300, in step 1020.

The electronic device 100, from the advertisement server 300, receives identification information of advertisement corresponding to device information of the electronic device 100, in step 1030.

The electronic device 100 determines whether advertisement image data corresponding to the received identification information of advertisement is stored in the storage, in step 1040.

In step 1040, when image corresponding to the identification information received from the advertisement server 300 is not stored in the storage (S1040:N), image data of another advertisement stored in the storage may be preferentially provided on the first screen, image data corresponding to identification information of the received advertisement may be received from the advertisement server 300, and storage may be updated, in step 1060. In the meantime, when the identification information of the advertisement received from the advertisement server 300 is stored in the storage (S1040:N), image data stored in the storage can be extracted and provided, in step 1050.

For example, when the advertisement can be provided within a preset period, and when to provide is not specified, image data (for example, advertisement which is not provided due to lack of image data in the storage in case of event occurrence) of another advertisement stored in the storage can be provided, and image data of the advertisement can be requested to the advertisement server 300 and storage can be updated.

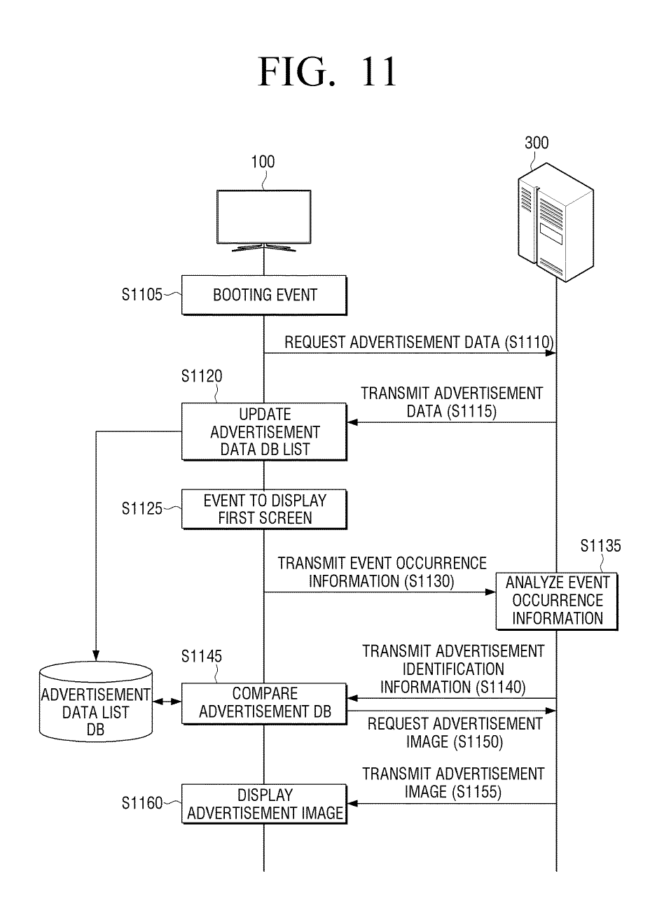

FIG. 11 is a sequence diagram illustrating an example operation relation between the electronic apparatus and an advertisement server, according to another example embodiment of the present disclosure.

According to FIG. 11, when booting event occurs in the electronic device 100, in step 1105, the electronic device 100 requests advertisement data to the advertisement server 300, in step 1110.

The advertisement server 300, when a signal for requesting advertisement data is received from the electronic device 100, transmits advertisement data corresponding to the electronic device 100 to the electronic device 100 in step S1115.

The electronic device 100 updates an advertisement data DB with advertisement data received from the advertisement server 300, in step 1120.

When the first screen display event occurs in the electronic device 100 in step 1125, the electronic device 100 transmits event occurrence information (or device information) to the advertisement server 300, in step 1130. The advertisement server 300 analyzes event occurrence information received from the electronic device 100 in step 1135 and transmits advertisement identification information to the electronic device 100, in step 1140.

Then, the electronic device 100, by comparing the received advertisement identification information with advertisement data stored in the DB, in step 1145, when there is no corresponding advertisement image, the advertisement image corresponding to the advertisement identification information is requested to the advertisement server 300, in step S1150.

Then, the advertisement server 300 transmits corresponding advertisement image to the electronic device 100 (S1155), and the electronic device 100, if an advertisement image is received from the advertisement server 300, displays a received advertisement image (S1160).

In the meantime, the method for controlling the electronic device 100 according to an example embodiment may be an application software type provided on a platform applied to the electronic device 100, but in some cases, it can be embodied so that it is implemented by application which is software a user comes to directly use on OS. In addition, an application can be provided as an icon interface format on the screen of the electronic device 100, but it is not limited thereto.

According to the present disclosure, by receiving and storing advertisement data at advertisement timing, advertisement can be provided without additional communication with an advertisement server and thus, user convenience would be improved.

In the meantime, each of the elements in the specification can include one or more components, and name of the element can be different according to a type of an electronic apparatus. In various example embodiment, an electronic apparatus can include at least one of the elements, a part of the elements can be omitted or other additional element can be further included. In addition, by combining a part of the elements of the electronic device as one entity, functions before combination can be performed in the same manner.

The example embodiments disclosed herein are provided for the explanation and understanding of the technical content, not to limit the scope of the technology described herein. Accordingly, the scope of the disclosure should be understood to include all the modifications or various other embodiments based on the technical ideas of the present specification.

On the other hand, as described above in various example embodiments in accordance with the electronic device and the server, the control method may include executable program code stored on various non-transitory computer readable medium to be executed by the processor and may be provided in each device or server.

As an example, when an event to display a first screen on a display occurs, a non-transitory computer readable medium which stores a program which executes transmitting device information of the electronic device to the advertisement server, when identification information of the advertisement corresponding to device information of the electronic device is received from the advertisement server, extracting image data corresponding to identification information received from the storage and providing the data on the first screen can be provided on a user terminal device.

For example, the above-described various applications or programs may be stored in a non-transitory apparatus-readable medium such as a compact disc (CD), a digital versatile disc (DVD), a hard disc, a Blu-ray disc, a universal serial bus (USB), a memory card, or a read only memory (ROM), and then may be provided to a user terminal device.

While the present disclosure has been illustrated and described with reference to certain example embodiments thereof, it will be understood by those skilled in the art that various changes in form and detail may be made therein without departing from the spirit and scope of the disclosure as defined by the appended claims.

What is claimed is:

1. An electronic device comprising:
a display;
a communicator comprising communication circuitry configured to communicate with an advertisement server;
a storage configured to store image data corresponding to identification information of an advertisement received from the advertisement server and image data corresponding to the identification information; and
a processor configured to transmit event occurrence information to the advertisement server in response to an event to display a first screen on the display occurring, to extract image data corresponding to the received identification information in response to identification information of an advertisement corresponding to the event occurrence information being received from the advertisement server, and to provide the extracted image data on the first screen.

2. The device as claimed in claim 1, wherein the processor is configured to transmit booting event occurrence information to the advertisement server to request advertisement data in response to the electronic device being booted, to receive, from the advertisement server, advertisement data including identification information of advertisement and image data corresponding to the identification information, and to update the storage.

3. The device as claimed in claim 2, wherein the processor is configured to compare identification information and image data of an advertisement stored in the storage with identification information and image data of an advertisement included in the received advertisement data, and to update data stored in the storage to a latest version advertisement data.

4. The device as claimed in claim 2, wherein the advertisement data received from the advertisement server further comprises effective period information of the advertisement, wherein the processor is configured to compare effective period information of the advertisement included in the received advertisement data and effective period information of the advertisement stored in the storage, and to update the stored data in the storage.

5. The device as claimed in claim 1, wherein the processor is configured to request, from the advertisement server, image data corresponding to the identification information of the advertisement in response to image data corresponding to identification information of the advertisement received from the advertisement server not being stored in the storage, and to provide the received image data on the first screen.

6. The device as claimed in claim 1, wherein the processor is configured to provide image data of a different advertisement stored in the storage on the first screen in response to image data corresponding to identification information of the advertisement received from the advertisement server not being stored in the storage, to receive image data corresponding to the received identification information of the advertisement from the advertisement server, and to update the storage.

7. The device as claimed in claim 6, wherein the processor is configured to provide image data of the different advertisement on the first screen and to request image data corresponding to the received identification information of advertisement to the advertisement server.

8. The device as claimed in claim 1, wherein the event occurrence information comprises at least one of: device information of the electronic device, the event type, and a number of the event occurrence.

9. A method of controlling an electronic device comprising identification information of advertisement received from an advertisement server and image data corresponding to the identification information, the method comprising:
transmitting event occurrence information to the advertisement server in response to an event to display a first screen occurring;
extracting image data corresponding to the received identification information in response to identification information of an advertisement corresponding to the event occurrence information being received from the advertisement server; and
providing the data on the first screen.

10. The method of claim 9, further comprising, transmitting booting event occurrence information to the advertisement server to request advertisement data in response to the electronic device being booted; receiving, from the advertisement server, advertisement data including identification information of advertisement and image data corresponding to the identification information; and updating the storage.

11. The method of claim 10, wherein the updating comprises comparing identification information and image data of the advertisement stored in the storage with identification information and image data of the advertisement included in the received advertisement data and updating data stored in the storage to a latest version of advertisement data.

12. The method of claim 10, wherein the advertisement data received from the advertisement server further comprises effective period information of the advertisement,
wherein the updating the storage comprises comparing effective period information of the advertisement included in the received advertisement data and effective period information of the advertisement stored in the storage and updating the stored data in the storage.

13. The method of claim 9, further comprising:
requesting, to the advertisement server, image data corresponding to the identification information of the advertisement in response to image data corresponding to identification information of the advertisement received from the advertisement server not being stored in the storage; and providing the received image data on the first screen.

14. The method of claim 9, further comprising:
providing image data of a different advertisement stored in the storage on the first screen in response to image data corresponding to identification information of the advertisement received from the advertisement server not being stored in the storage; and
receiving image data corresponding to the received identification information of the advertisement from the advertisement server and updating the storage.

15. The method of claim 14, wherein the updating the storage comprises providing image data of the different advertisement on the first screen and requesting image data corresponding to the received identification information of the advertisement to the advertisement server.

16. The method of claim 9, wherein the event occurrence information comprises at least one of: device information of the electronic device, the event type, and a number of the event occurrence.

17. A non-transitory recording medium storing a program which, when executed by a processor, causes the processor to perform operations of a method of providing an advertisement of an electronic device including a storage which stores identification information of advertisement received from an advertisement server and image data corresponding to the identification information, wherein the method comprises:
transmitting the event occurrence information to the advertisement server in response to an event to display a first screen occurring; and
extracting image data corresponding to the received identification information from the storage in response to identification information of an advertisement corresponding to the event occurrence information being received from the advertisement server, and providing the image data on the first screen.
